(19) United States
(12) Patent Application Publication
(10) Pub. No.: US 2022/0180280 A1
(43) Pub. Date: Jun. 9, 2022

(54) SYSTEM FOR USE IN PERFORMANCE AND TRACKING OF CLEANING TASKS

(71) Applicant: Marquis Brignac, Pacoima, CA (US)

(72) Inventor: Marquis Brignac, Pacoima, CA (US)

(21) Appl. No.: 17/111,369

(22) Filed: Dec. 3, 2020

(51) Int. Cl. G06Q 10/06; G06F 3/0488; G06F 3/0481

(52) U.S. Cl. CPC G06Q 10/06316; G06F 3/04815; G06F 3/0488; G06Q 10/06398

(57) ABSTRACT

A task tracking system is provided, including a task tracking device having a plurality of no more than four input elements, the task tracking device configured to track user progress on specific tasks assigned to a user. The task tracking device enables task tracking and provides information to the user according to a user interface limiting user input to the plurality of no more than four input elements. The system also includes a central processing arrangement having at least one computing device, the central processing arrangement configured to receive task performance data from the task tracking device and provide tasks specific to the user and to be completed by the user to the task tracking device.

### BACKGROUND OF THE INVENTION

### Field of the Invention

The present invention relates generally to tracking devices and methods, and ore specifically to devices and methods for performing and tracking performance of cleaning tasks.

### Description of the Related Art

Persons performing cleaning tasks have traditionally employed either no system of tracking or accounting for the performance of such tasks, or at most have used pencil and paper. In some cases, a person may have an ongoing responsibility to clean a given area or facility and may simply do so. If any issue occurs, particularly when multiple people are responsible for cleaning the area, it can be impossible to identify when projects were completed, precisely what was done, and who performed what task.

Pencil and paper tracking can be inadequate in many instances, particularly when tracking large cleaning jobs and who performs which cleaning tasks, as well as when the tasks were completed. For example, a group may be required to clean areas A, B, and C, and simply must initial completion of cleaning of each area. A supervisor or other person may simply initial the completion. If the job is performed inadequately, it can be difficult or impossible to assess what went wrong and correct the procedure, if the procedure was actually inadequate.

Problems may also exist with unscrupulous cleaning personnel. At a minimum, such persons may sign off approval of tasks that were not completed. Inattention can also be an issue, where it is believed job X was completed when in fact it was not.

One other solution has been to use smartphones or other commonly available computing devices to track the performance of such tasks. However, such devices can be difficult to use when, for example, the user is wearing gloves. Also, cleaning includes the use of chemicals that can harm smartphones and other computing devices. In these instances, checklists cannot be updated while the employee is working on a task in most situations. Apps must be downloaded and several entities do not permit use of smartphones in such situations for health and safety reasons.

These various issues suggest improvement of previous cleaning task performance and tracking methods. It would be desirable to offer a system or method that improves on such previous cleaning task performance and tracking issues.

### SUMMARY OF THE INVENTION

According to one embodiment, there is provided a task tracking system comprising a task tracking device comprising a plurality of no more than four input elements, the task tracking device configured to track user progress on specific tasks assigned to a user, wherein the task tracking device enables task tracking and provides information to the user according to a user interface limiting user input to the plurality of no more than four input elements, and a central processing arrangement comprising at least one computing device, the central processing arrangement configured to receive task performance data from the task tracking device and provide tasks specific to the user and to be completed by the user to the task tracking device.

According to a further embodiment, there is provided a method for managing performance and completion of tasks, comprising associating a user with a task tracking device comprising a plurality of no more than four input elements, the task tracking device configured to track user progress on specific tasks assigned to the user, wherein the task tracking device enables task tracking and provides information to the user according to a user interface limiting user input to the plurality of no more than four input elements, receiving task performance data provided by the user from the task tracking device at a central processing arrangement, and providing tasks specific to the user and to be completed by the user from the central processing arrangement to the task tracking device.

According to another embodiment, there is provided a task tracking system comprising a task tracking device comprising a plurality of no more than four input elements, the task tracking device configured to receive user task completion information and track user progress on specific tasks assigned to a user, wherein the task tracking device provides information to the user according to a user interface limiting user input to inputs provided on the task tracking device, and a central processing arrangement comprising at least one computing device, the central processing arrangement configured to receive task performance data from the task tracking device and provide tasks specific to the user and to be completed by the user to the task tracking device.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates one embodiment of a task tracking device according to the present design;

FIG. 2 is an alternate view of the task tracking device of FIG. 1;

FIG. 3 shows a representation of a task tracking system in accordance with the present design;

FIG. 4 represents a sample user interface screen for the task tracking device; and

FIG. 5 is a further sample user interface screen illustrating alternate button functionality.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

The present design includes a device employed to track specific issues related to cleaning, including but not limited to performance of tasks and tracking the performance of tasks down to time completed and person or entity completing the task. Tasks may be split into smaller or larger items, such as “clean building 6” down to “clean soap dispenser number 4 in restroom C on floor 27” for example. Other tasks can be tracked, but in one embodiment the design is particularly directed to cleaning task tracking.

The device comprises a conveniently designed apparatus that can be carried or maintained by a user performing cleaning tasks. The present device is an end to end process management, timing, implementation and tracking platform with a suggested external configuration. With the present design, the user can perform cleaning tasks and account for completions of such tasks, enabling tracking and accountability for tasks created. Tasks can be changed as desired. The present system allows for the ability to create procedures and/or steps, establish a time per step, materials to be used and actually used, and safety information among other attributes. The system can create entities, such as companies, municipalities, and departments, as well as roles and employees or other personnel. Procedures may be assigned to personnel, and performance of tasks ma be tracked when executed. In one embodiment, a remote server or computing arrangement may be provided wherein data retrieved from the device may be collected from the device and the platform, including sites, tasks, and personnel may be administered. The platform may include ability to employ in some respects a variety of computing devices, including but not limited to smartphones, personal computers, tablets, and so forth. The present design may, in certain instances, be employed with gloves at times when mobile device/smartphone use is not appropriate.

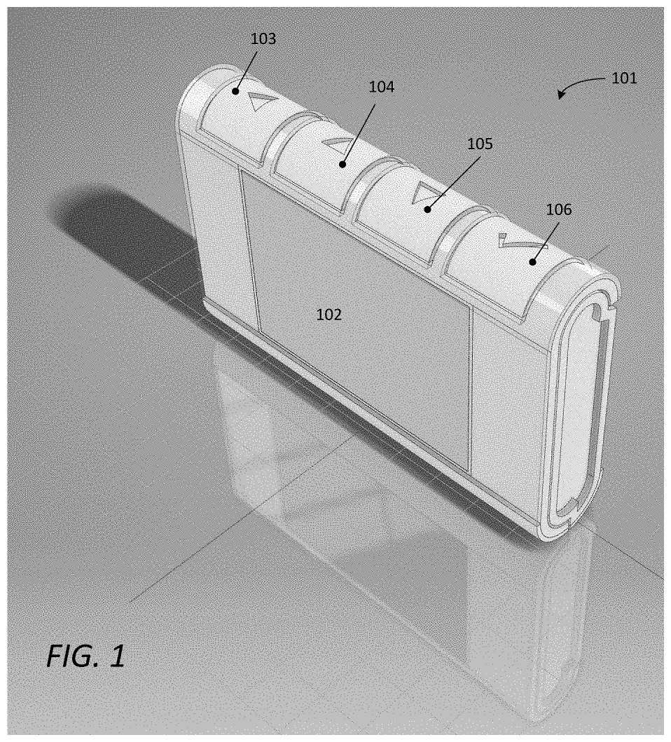

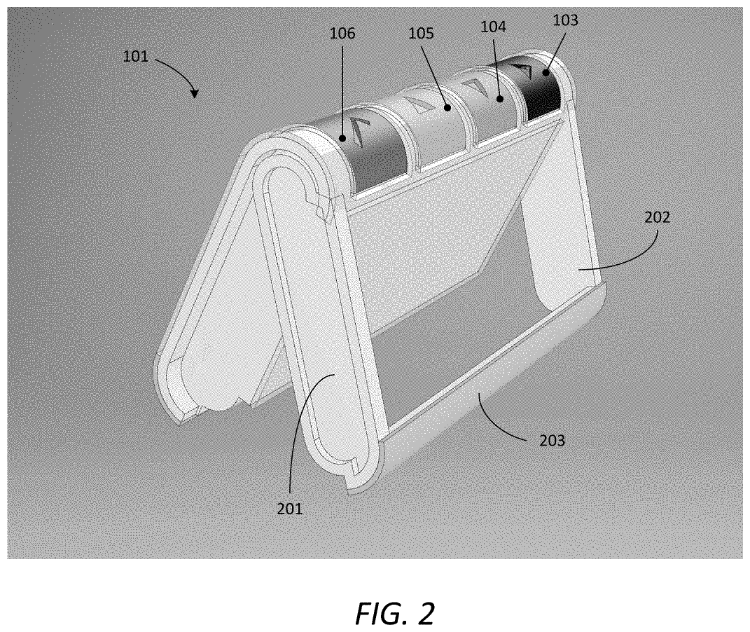

FIG. 1 illustrates a first representation of the design. From FIG. 1, task tracking device 101 includes a screen 102 and multiple buttons, in this instance four buttons 103, 104, 105, and 106. FIG. 2 illustrates the design opened, with side support elements 201 and 202 pivoting about an internal element or pivoting like a hinge, with base 203 also shown. Functionality is restricted such that the user can select all options using one of the four buttons provided. Screen 101 may be a standard computing device screen or may be a touchscreen.

As may be appreciated, the present design must allow for tracking of tasks using the limited number of buttons provided. While four buttons are shown in FIGS. 1 and 2, it is to be understood that fewer or more buttons may be provided, and again, a touchscreen may be provided. Providing limited touchscreen capability in the device may be beneficial, as it is anticipated that persons using the present design may be wearing gloves. Thus fine motor detection may be impossible. Thus in the configuration shown, if a touchscreen is employed, the touchscreen may be considered a limited input device, such as having one, two, three, or a small number of capable inputs. For example, simple pressing may be one input, swiping right or left, possibly up and down, and so forth may be provided with the touchscreen. Touchscreen sensitivity in the presence of gloves should be considered, with the understanding that gloves may take different forms, from medical style small thickness gloves to thick gloves used in harsh conditions or in the presence of strong chemicals. The system may take into account expected conditions employed by the user. For example, if a user is anticipated to wear thick gloves because he or she is using strong acids, no touchscreen functionality may be offered and the user may be restricted to employ buttons provided.

The buttons provided on task tracking device 101 may include different indications and may be of different colors and/or textures. In one embodiment, button 103 is a left pointing triangle or arrow, button 104 an upward pointing triangle or arrow, button 105 a downward pointing triangle or arrow, and button 106 a check mark or in another embodiment a rightward pointing triangle or arrow. Different texture buttons may be provided such that the user can differentiate the buttons when they cannot be seen, such as when the device is in the user's pocket. Different colors, such as red, green, blue, and black may be employed such that the user may more readily see and differentiate each button, and certain other attributes may be provided, such as using glow-in-the-dark colors for the buttons.

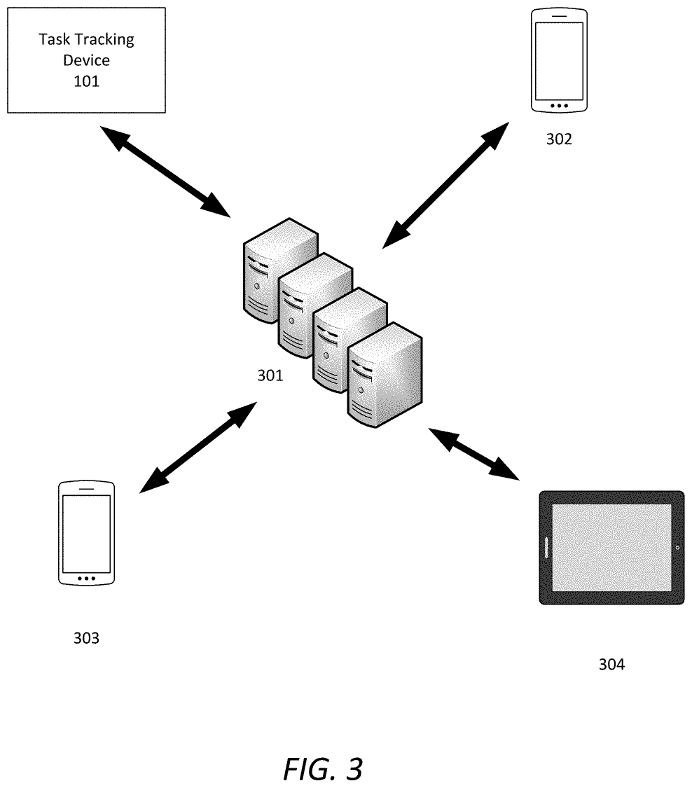

FIG. 3 illustrates one embodiment of the system contemplated herein. Task tracking device 101 may interface with a central computing arrangement 301, which may in turn interface with one or more of an iOS (Apple) mobile device 302, an Android mobile device 303, and/or another compatible device 304. An individual user may have multiple devices at his disposal, such as a smartphone, tablet, and a task tracking device. Functionality may be divided between these platforms and not repeated on each platform. Sections of functionality may be provided and potentially addressed on more than one platform. For example, a checklist may appear on a mobile device and on the task tracking device 101. Creating checklists on task tracking device 101 can be difficult or impossible, and thus the central computing arrangement 301 may be used for this task, as well as other appropriate devices (personal computer, mobile device(s), etc.) Administration and user management tasks may be too difficult to execute on the mobile platform, and the central computing arrangement 301 may be used for administration, such as tracking, updating, and so forth. Users updating an established checklist may employ a mobile device and/or the central computing arrangement 301 as opposed to logging into a website to update the checklist.

Functionality in the present design is divided based on efficiency. Different platforms or components may execute the same functionality differently. Each component class may employ a different user interface and users may navigate differently on each user interface. An Apple or Android smartphone may have a relatively large screen display, whereas the task tracking device 101 typically employs a smaller low resolution display. A smartphone (Apple, Android) can be touched for button presses, whereas the electronic device provides a limited number of physical buttons to navigate the UI on a smaller and simpler screen, and potentially a limited functionality touchscreen.

An administrative function is provided that creates customer entities, roles and users in the system. Each company has its own data to allow different customers to use the system safely with private data. Typical fields in establishing entities include entity name, entity address, entity contact details, primary contact, and “active” status, to disable an entity if required. Roles may include a role name, rights to view (read, edit, none) and so forth. Roles allows for creating different types of users and access rights. As an example, a role of Entity Administrator may be employed, and a person having this identity/role may create more users for the entity as well as other roles, such as manager, custodian, etc. Roles may be established for multiple or all entities, i.e. may apply to multiple entities, including but not limited to roles such as “custodian” “janitor” “supervisor” and so forth in order to allow standardization for multiple or all entities. As an example, a government employee may be established by his government pay level, i.e. level 13 government employee. In one embodiment, only a super administrator may have rights to modify roles. A given role may be assigned to a department or organization in one embodiment. Permissions may be granted based on role or department/organization. For example, if the user has a custodian role but belongs to a cleaning department, if the cleaning department has permission to view information but the custodian role does not, the system may allow viewing by the individual in the custodian role.

Departments provide a mechanism for creating groups within entities. The system enables assigning roles to individuals or departments/organizations. A department/organization may belong to an entity (root) or may belong to a superior department/organization as a child. Department is hierarchical and can have parent child relations to other departments, and departments can be named and have a parent entry.

The top level administrator or another entity or individual, such as a customer administrator, can create users in the system. The top level administrator, or super administrator, can assign users to roles and/or to any entity. In one embodiment, an administrator for an entity can only create users and assign them to roles for his/her entity. Creating a user calls for establishing fields such as FirstName, LastName, UserName, password, email address, contact (mobile) number, entity/company, department/organization, role, and an “active” indication, allowing for disabling a user. Roles and users can be administered by appropriate personnel, including but not limited to a super administrator or an entity or customer administrator.

A customer administrator may create roles that are a subset of his/her own permissions. If a customer or entity administrator does not have an ability to create other entities or companies, he or she may not assign such a role to other users. The system applies the same administrator authority or rule to other users. The system only allows permissions and rules of a created user to be at most those of the creating entity.

The system may allow for creation of a procedure creator role, such as a position of procedure manager. Procedures are a group of hierarchical checklists. Many industries have standard procedures that may adhere to certain health and safety requirements. Procedures can be saved centrally. A designated procedure manager uses the system to create a procedure from a template, but can modify and save the procedure under a different name, or create a new template for the entity. An administrator with appropriate authority may create a procedure, where such a procedure has a name and may have a parent procedure. Each procedure may have steps, where one step is an independent task having a task name, task description, an optional graphic to represent the task step visually, and a time the task should take (where leaving this time at zero allows unlimited time) in one embodiment. Steps may be presented to the end user, such as an end user using a task tracking device 101, in the form of a checklist.

A given procedure may include materials to be used in performing the procedure, such as a cleaning procedure. The system may receive and provide a listing of materials to use is in the procedure by name, a description of the material (e.g. bottle of Company X cleaning fluid—green liquid). Each procedure may include a safety checklist, such as a name of a safety step, a description of the safety step, and may require acknowledgement from the user. A given procedure may have some global rules associated. In one embodiment, a user may acknowledge completion of each step such as via a checkbox, may acknowledge availability of each material required, again such as via a checkbox, and may select a checkbox that acknowledges understanding of each safety step.

A role of allocation manager is a role that enables the allocation of work assignments to individual employees or groups. An allocation manager can create a new assignment in the system, where an assignment includes name, description, procedures to include, and assignment to an individual user or group. The system allows the appropriate individual to create a group or an existing group can be used. Individual users can be assigned to the group, or an entire department can be assigned to the group. A period of assignment can be assigned representing how often the assignment must be executed, including start date, end date, frequency of performance, and an indication whether the assignment is active or not.

A user may indicate execution of an assignment on a smartphone device or other portable device or task tracking device 101. One embodiment of checklist execution is as follows. The system transmits a communication, such as an email, to the user when his/her account is created. Such a communication invites the employee to install functionality on his or her personal device. The user may create a password. The system may confirm the user is set up on the system. Once a user logs into the central server arrangement, he or she may be presented with assignments. The system presents the user selecting an assignment with the name of the assignment, total allowed time, actual time taken, actual time remaining, and estimated percentage complete. If an assignment is anticipated to take 20 minutes, and the user has initiated the assignment, at the ten minute mark the user is advised by the system that the job should be 50 percent complete. The system also provides a scrollable list of steps with checkboxes to track completion and may in one embodiment include a color-coded background timeline showing percentage complete, i.e. where should be by the present time. The user may be offered a start button and stop button to start and stop the checklist measurement. When the user starts the assignment, the system provides each step in a relatively large and easy to read format. Once the user starts the checklist, she can check every item in the checklist upon completion. In case of an error, the system allows the last item to be unchecked. Previous items typically cannot be unchecked once checked to avoid issues with time recordation. The checklist can be executed in order of the steps. Uncheckable items have their checklists disabled. Data can be synchronized with the central computing arrangement 301 as the checklists are updated.

An assignment may include safety and equipment selection capability by one or more of the buttons available. Selecting safety or equipment provides the user with the safety or equipment associated with the assignment on the user smartphone or the task tracking device 101.

The system presents the user with his or her performance on the checklists. Reports provided by the system may include a checklists completed report showing steps completed by the user over a desired period, such as the last day, week, or month, and a time report showing the user how punctual he was in following the requisite steps.

The user can customize features on the system. She can of course log in and log out, and can update personal information, can manage notifications, can contact a help desk, can obtain an overview how to use the system, and can allow the user to scan the QR code of task tracking device 101 and associate the task tracking device with the user or her account. Audio read out of instructions may be provided, and electronic assistant support (Google Assistant, Siri, etc.) may be provided.

The task tracking device 101 typically includes a small color screen, an audio speaker, LED indicators, Microphones for audio input, and in one embodiment four large buttons for operation with gloves. When four buttons are used, functionality may include up, down, back, and select. The task tracking device 101 typically has a separate power on/off button to start the device or switch it off. A rechargeable battery may be provided with a standard connection, such as a micro-USB connection.

Operation entails the user switching on the task tracking device 101. If not already registered with the device, the system prompts the user to register the device. Upon identifying the user, the system provides the user with his current checklists, and in one embodiment, identifies completed and incomplete tasks or assignments. A user desiring to perform a task or assignment selects the task or assignment by scrolling through the list and selecting the task or assignment using the ‘Select’ button. The system allows the user to scroll down the list, such as by using the “down” button, and select checkboxes as she completes the task or assignment. In one embodiment, selectable by the user, the task tracking device 101 may audibly read the task using a speaker. To complete a step, the user can tap on the select button on task tracking device 101, using a bare hand or a gloved hand.

The task tracking device 101 may have indicators, such as LED light indicators, that blink and/or change color to indicate completion of a step, or expiration of time, or time to move to a next task, for example. A light may be provided on the device allowing functioning as a flashlight. The task tracking device 101 may include a Wi-Fi or Bluetooth or cellular transmitter enabling communication a Mobile device and may provide information and distribute information to other relevant devices, including and via central computing arrangement 301.

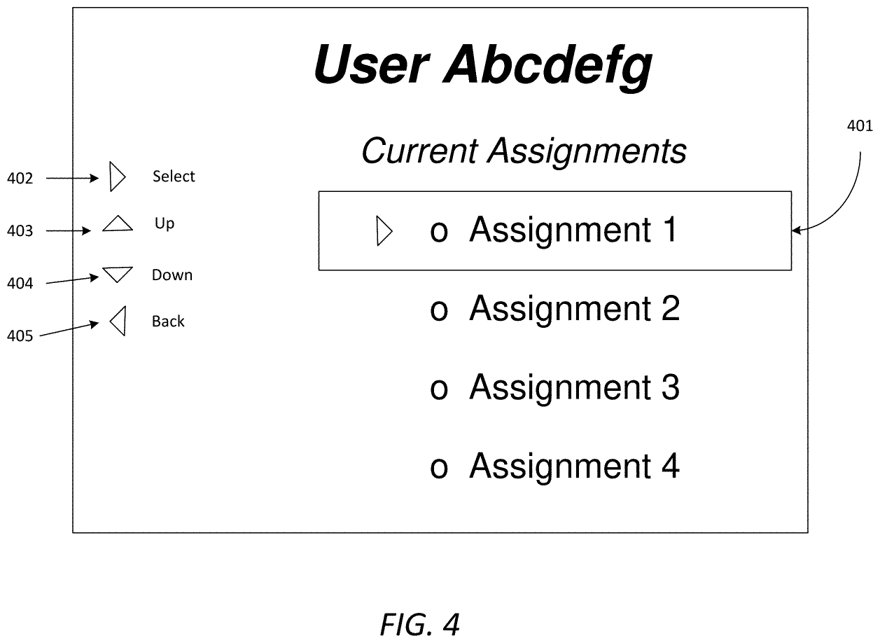

Thus one aspect of the present design is the function of enabling the user to track tasks, such as cleaning or janitorial tasks, using a device having few buttons, such as a plurality of buttons but less than four, five, eight, or possibly ten buttons depending on the implementation. For a four button situation as shown in FIG. 1, as may be appreciated, ability to effectuate the functionality described herein may present challenges. As an example, FIG. 4 illustrates one interface screen applicable to a user employing the task tracking device 101 with limited buttons, such as four. The user has four assignments to complete, each of which is listed, with task 401 highlighted. The indicators on the left may be provided to the user, or may be missing, particularly when being used by those familiar with the task tracking device 101. Top indicator 402 is the “select” indication, showing the button to push to select the highlighted task 401. Second indicator 403 is the “up” indicator, indicating selecting the “up” button causes the selection and highlighting to move upward from task 401, while third indicator 404 is the “down” indicator, indicating selecting the “down” button causes the selection and highlighting to move downward from task 401. Third indicator 405 is the “back” indicator, indicating the user can go back to a previous screen. In general, the screens and user interface are in a tree structure enabling functionality similar to the indicators presented in FIG. 4.

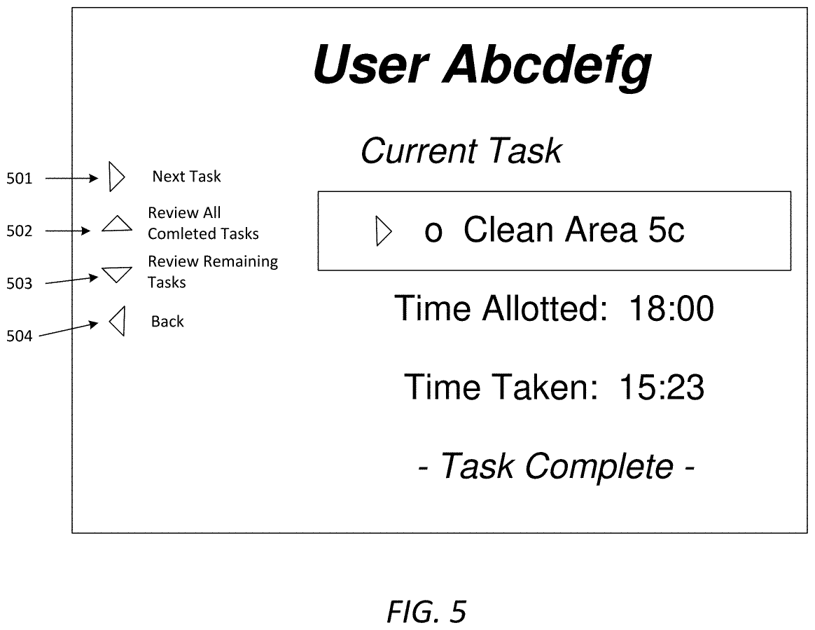

However, in some instances, different functionality other than down, up, left, and right may be provided, and either engaged or initiated by the user, using the buttons available. FIG. 5 is an example of such a screen. From FIG. 5, the user is presented with a completed task, where the time required to complete the task is 18 minutes, he has completed the task in 15 minutes and 23 seconds, and he is presented with options to move to the next task 501, review all task completions 502, or review remaining tasks 503. He can also go back to the previous screen as shown by indicator 504. The review of task completions 502 and review remaining tasks options can be selected using the up or down buttons respectively, which neither providing an up or down function.

All of the functionality described herein thus accounts for the limited number of buttons or inputs available. N the case of four buttons, the user interface and options presented account for the limited number of buttons in order to be able to identify the user, review current tasks and assignments, and time the execution of such tasks. The system further includes the ability to provide information to a central computing arrangement 301 and allow for tracking of task completions by persons with a need to know. Button functionality with respect to the information provided may be expanded. For example, pressing a combination of more than one button, such as two or three buttons, may provide additional inputs and/or information. For example, pressing buttons one and three may be offered to reset the device, cancel an operation, or otherwise, and pressing two, three, or four buttons may enable the user to select different or additional functions in this embodiment.

Smartphone, tablet, and other functionality may be provided to track, report, or review tasks and assignments. Functionality for such devices may be broader than those of task tracking device 101 as they may enable more than four, five, or a limited number of inputs available to the user of task tracking device 101. And again, use of devices such as smartphones, tablets, etc. may be undesirable due to the chemicals involved, limitations on use of such devices by entities such as corporations employing the user, and need for the use of gloves when logging or tracking data. Note that the present design contemplates that the task tracking device 101 is specifically designed for cleaning use, and may be provided with an exterior and buttons and a screen that are resistant to certain chemicals, wither by their composition or by coatings or coverings provided. While not every chemical can be addressed, the exterior may be designed to be impervious to one or more classes of common chemicals, such as common cleaning chemicals. A separate cover may be provided with task tracking device 101.

Thus the present design offers an overall system for task tracking including a unique task tracking device that is typically used with a central server arrangement and may include functionality provided on other devices, including but not limited to smartphones, tablets, and personal computers. The devices allow users to be identified and in some instances associated with a device such as the task tracking device, wherein a list of tasks and assignments can be provided and tracked. In all instances, the user interface and functionality provided on or with task tracking device take into account the limited number of inputs available on the device, which may be a plurality of inputs or buttons, and in some cases no more than 4, 5, 6, 8, 9, or 10. Functionality may also or alternately be provided on handheld devices such as smartphones or tablets, and may be provided on personal computer. The system allows for roles, tasks, users, and other relevant information to be established and in one embodiment managed and maintained at a central server or computing device arrangement.

Thus according to one embodiment, there is provided a task tracking system comprising a task tracking device comprising a plurality of no more than four input elements, the task tracking device configured to track user progress on specific tasks assigned to a user, wherein the task tracking device enables task tracking and provides information to the user according to a user interface limiting user input to the plurality of no more than four input elements, and a central processing arrangement comprising at least one computing device, the central processing arrangement configured to receive task performance data from the task tracking device and provide tasks specific to the user and to be completed by the user to the task tracking device.

According to a further embodiment, there is provided a method for managing performance and completion of tasks, comprising associating a user with a task tracking device comprising a plurality of no more than four input elements, the task tracking device configured to track user progress on specific tasks assigned to the user, wherein the task tracking device enables task tracking and provides information to the user according to a user interface limiting user input to the plurality of no more than four input elements, receiving task performance data provided by the user from the task tracking device at a central processing arrangement, and providing tasks specific to the user and to be completed by the user from the central processing arrangement to the task tracking device.

According to another embodiment, there is provided a task tracking system comprising a task tracking device comprising a plurality of no more than four input elements, the task tracking device configured to receive user task completion information and track user progress on specific tasks assigned to a user, wherein the task tracking device provides information to the user according to a user interface limiting user input to inputs provided on the task tracking device, and a central processing arrangement comprising at least one computing device, the central processing arrangement configured to receive task performance data from the task tracking device and provide tasks specific to the user and to be completed by the user to the task tracking device.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A task tracking system comprising:
a task tracking device comprising a plurality of no more than four input elements, the task tracking device configured to track user progress on specific tasks assigned to a user, wherein the task tracking device enables task tracking and provides information to the user according to a user interface limiting user input to the plurality of no more than four input elements; and
a central processing arrangement comprising at least one computing device, the central processing arrangement configured to receive task performance data from the task tracking device and provide tasks specific to the user and to be completed by the user to the task tracking device.

2. The task tracking system of claim 1, wherein the task tracking device and central processing arrangement are employed in tracking of cleaning tasks.

3. The task tracking system of claim 1, further comprising a user computing device configured to receive task assignment information from the central processing arrangement and task completion information from the user and provide task completion information to the central computing arrangement.

4. The task tracking system of claim 1, wherein the task tracking device is configured to associate the task tracking device with a specific user.

5. The task tracking system of claim 1, wherein the task tracking device comprises a screen configured to display task related information to the user.

6. The task tracking system of claim 1, wherein the plurality of no more than four input elements each comprise a visual functional indication, and the task tracking device is configured to provide functionality differing from at least one visual functional indication.

7. A method for managing performance and completion of tasks, comprising:
associating a user with a task tracking device comprising a plurality of no more than four input elements, the task tracking device configured to track user progress on specific tasks assigned to the user, wherein the task tracking device enables task tracking and provides information to the user according to a user interface limiting user input to the plurality of no more than four input elements;
receiving task performance data provided by the user from the task tracking device at a central processing arrangement; and
providing tasks specific to the user and to be completed by the user from the central processing arrangement to the task tracking device.

8. The method of claim 7, wherein the task tracking device and central processing arrangement are employed in tracking of cleaning tasks.

9. The method of claim 7, further comprising:
receiving task assignment information at a user computing device from the central processing arrangement;
receiving task completion information at the user computing device from the user; and
providing task completion information from the user computing device to the central computing arrangement.

10. The method of claim 7, wherein the task tracking device comprises a screen configured to display task related information to the user.

11. The method of claim 7, wherein the plurality of no more than four input elements each comprise a visual functional indication, and the task tracking device is configured to provide functionality differing from at least one visual functional indication.

12. A task tracking system comprising:
a task tracking device comprising a plurality of no more than four input elements, the task tracking device configured to receive user task completion information and track user progress on specific tasks assigned to a user, wherein the task tracking device provides information to the user according to a user interface limiting user input to inputs provided on the task tracking device; and
a central processing arrangement comprising at least one computing device, the central processing arrangement configured to receive task performance data from the task tracking device and provide tasks specific to the user and to be completed by the user to the task tracking device.

13. The task tracking system of claim 12, wherein the task tracking device and central processing arrangement are employed in tracking of cleaning tasks.

14. The task tracking system of claim 12, further comprising a user computing device configured to receive task assignment information from the central processing arrangement and task completion information from the user and provide task completion information to the central computing arrangement.

15. The task tracking system of claim 12, wherein the task tracking device is configured to associate the task tracking device with a specific user.

16. The task tracking system of claim 12, wherein the task tracking device comprises a screen configured to display task related information to the user.

17. The task tracking system of claim 12, wherein the plurality of no more than four input elements each comprise a visual functional indication, and the task tracking device is configured to provide functionality differing from at least one visual functional indication.

18. The task tracking system of claim 16, wherein the screen comprises a touchscreen that provides an additional user input to the task tracking device.

19. The task tracking system of claim 12, wherein four engageable buttons are provided on the task tracking device.
